(19) United States
(12) Patent Application Publication
(10) Pub. No.: US 2019/0085636 A1
(43) Pub. Date: Mar. 21, 2019

(54) Safe Ladder- Safety Ladder Harness

(71) Applicant: Simone Gloria Simon, Jamaica, NY (US)

(72) Inventor: Simone Gloria Simon, Jamaica, NY (US)

(21) Appl. No.: 15/705,305

(22) Filed: Sep. 15, 2017

(51) Int. Cl. E06C 7/18

(52) U.S. Cl. CPC E06C 7/18

(57) ABSTRACT

Safe Ladder-Safety Laddery Harness is a new discovery for those whose climb ladders frequently. Safe Ladder-Safety Ladder Harness will keep you safe on any ladder! Just mount the sensor safety line eye bolts to the top and bottom and connect them with the safety braided steel cable. Now you can attach the safety retractable lanyard to the top and pull down the safety line. Put on the safety belt and attach the belt to the safety line from the retractable lanyard. When you climb a ladder, the tractable lanyard will retract and give you an extra safety element when climbing a ladder. It has a universe design to mount most ladders. Safe Ladder-Safety Ladder Harness is the safety device everyone needs to use when climbing a ladder. It's a perfect to resolve the problem of falling off a ladder.

### CROSS-REFERENCE TO RELATED APPLICATIONS

N/A

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

N/A

### STATEMENT REGARDING PRIOR DISCLOSURES BY THE INVENTOR OR A JOINT INVENTOR

The substitute specification contains no new matter.

### BACKGROUND OF THE INVENTION

### (1) Field of the Invention

Industrial

### (2) Description of Related Art Including Information Disclosed under 37 CFR 1.97 and 1.98

Safe Ladder-Safety Ladder Harness is an industrial invention that is intended to use with a ladder. It works codependently with a ladder to create fewer falls and accidents.

### BRIEF SUMMARY OF THE INVENTION

Safety Ladder-Safety Ladder Harness is invented to keep you safe as you climb up and down a ladder.

### BRIEF DESCRIPTION OF THE SEVERAL VIEWS OF THE DRAWING(S)

FIG. 1 show safety retractable lanyard harness.

FIG. 2 braided steel-cable safety line.

FIG. 3 shows safety leather webbing belt.

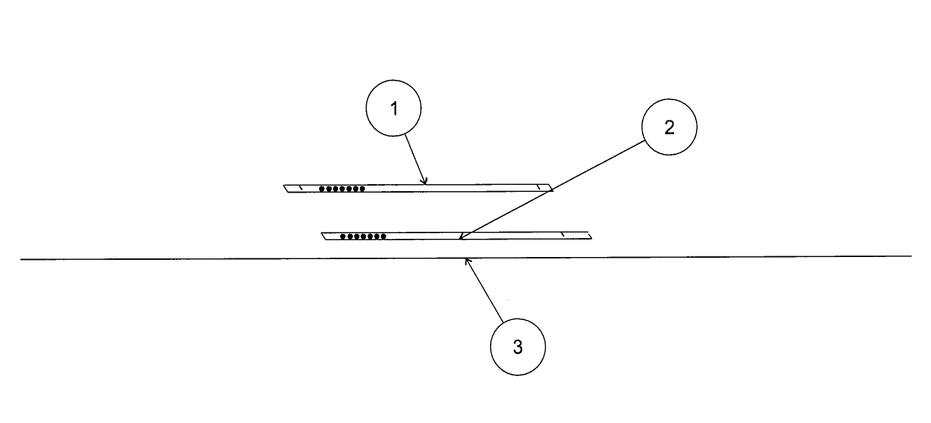

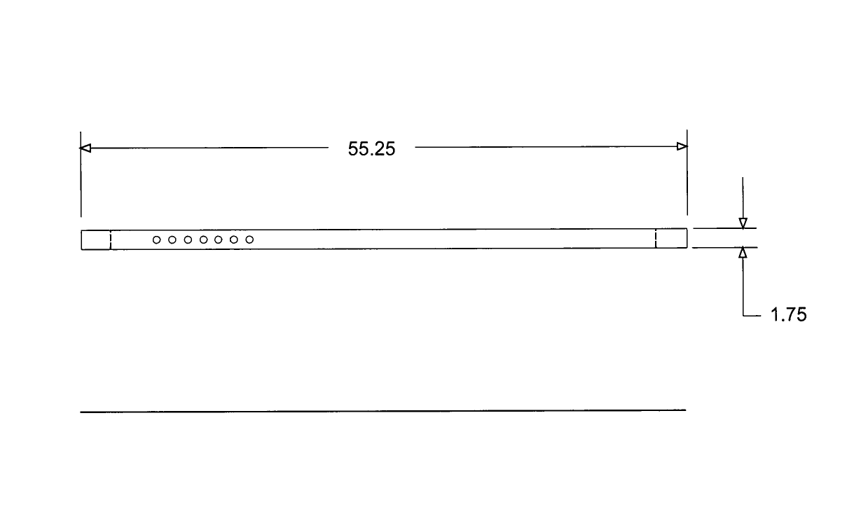

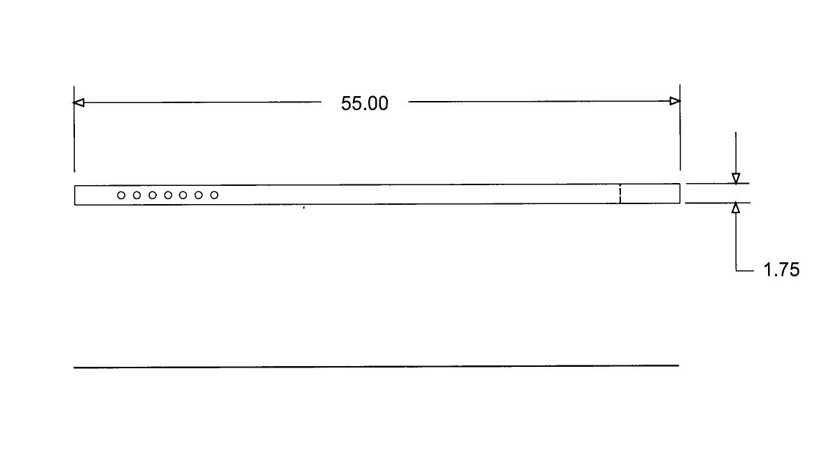

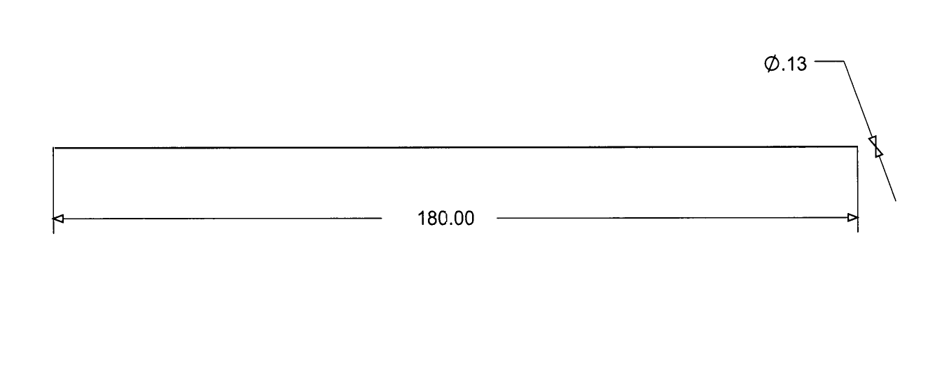

### DETAILED DESCRIPTION OF THE INVENTION

Safe Ladde-Safety Ladder Harness is a new invention for those who climb ladders frequently. Just mount the sensor safety line eye bolts to the top and bottom and connect them with the safety braided steel cable. Now you can attach the safety retractable lanyard to the top and pull down the safety line. Put on the safety belt and attach the belt to the safety line from the retractable lanyard. When you climb a ladder, the tractable lanyard will retract and give you an extra safety element when climbing a ladder. It has a universe design to mount most ladders. Safe Ladder-Safety Ladder Harness is the safety device everyone needs to use when climbing a ladder. Through many hours of design strategy implementation, we have accomplished our goal: a cost-effective and easy to manufacture product. It has a cut-and-sewn leather, a cut-and-sewn nylon webbing strap, and a cut to length braided steel cable. A prototype product sample has been built, and Pro-E technical drawings are available.

1. I claim: a Safe Ladder-Safety Ladder Harness which is a leather belt, a nylon strap and a braided steel cable; just mount the center eye blot to the top and bottom rung and connect them with the safety braided steel cable; now you can attract the safety triangular lanyard to the top and pull down the safety line; put on the safety and attract the belt to the safety line from the retractable lanyard; when you climb the ladder the retractable lanyard will react and give you an added safety element.
